(19) United States
(12) Patent Application Publication
(10) Pub. No.: US 2019/0202014 A1
(43) Pub. Date: Jul. 4, 2019

(54) DEVICE FOR THE AUTOMATED COUPLING AND DECOUPLING OF A TOOL ATTACHMENT, AS WELL AS METHOD FOR THE AUTOMATED CONNECTION OF AT LEAST TWO WORKPIECES

(71) Applicant: DÜRR ASSEMBLY PRODUCTS GMBH, Püttingngen (DE)

(72) Inventors: Christian BRACH, Wiesviller (FR); Armin HERRMANN, Riegelsberg (DE)

(73) Assignee: DÜRR Assembly Products GmbH, Püttlingen (DE)

(21) Appl. No.: 15/781,768

(22) PCT Filed: Dec. 7, 2016
(86) PCT No.: PCT/DE2016/100568

§ 371 Date: Mar. 8, 2019

(30) Foreign Application Priority Data
Dec. 7, 2015 (DE) 10 2015 121 287.0

(51) Int. Cl. B23Q 3/155; B23Q 3/157

(52) U.S. Cl. CPC B23Q 3/15506; B23Q 3/15526; B23P 19/06; B23Q 2003/15527; B23Q 3/15706

(57) ABSTRACT

The present invention relates to a device for the automated coupling and decoupling of a tool attachment from a tool drive means. The tool attachment and the tool drive means are configured to actuate a connection means for the connection of at least two workpieces. The connection means can be a screw or a bolt. The tool attachment can be coupled with and released from the tool drive means, in that the tool attachment is placed on the tool drive means. According to the invention, a magazine is present, having at least one tool attachment receiving space as well as holding means for the tool attachment in the tool attachment receiving space. The tool drive means is moveable in the axial direction with respect to the tool attachment for coupling as well as releasing the tool attachment with respect to the tool drive means. The tool attachment is held on the tool drive means in a form-fit manner. Coupling and decoupling occurs in an automated manner.

The present invention relates to a device for the automated coupling and decoupling of a tool attachment of a tool drive means according to the preamble of claim 1, as well as a method for the automated connecting of at least two workpieces according to the preamble of claim 8.

Connecting means that can be embodied as a screw are known. These screws may comprise a slot, a cross-slot, a blind hole, the outer edges of which are formed as a hexagonal socket, or the outer edges of which are configured to receive a so-called Torx drive, or a configuration of the outer periphery at an end of the screw, which is formed as a hexagon head. The screws can be picked by a correspondingly designed tool attachment, which can be formed as a screw driver, cross-slot screw driver, hexagon socket drive, Torx drive, or as a hexagon head. Other configurations of the screw, by means of which the screw can be picked with a tool attachment, can be implemented as well. The tool attachment can be formed as a so-called bit or as a so-called wrench socket, which can be inserted in a corresponding receptacle of the tool drive means or can be plugged on to the upper end of a tool drive means.

In order to achieve a certain holding force for the tool attachment on the tool drive means, it is known to provide a spring-elastically mounted ball on the tool drive means, which partially protrudes to the side at the upper end of the tool drive means. When plugging the tool attachment on or in, this ball is pressed into the upper end of the toll attachment means against the spring force, so that the tool attachment can be plugged-on or plugged in. In the final position of the tool attachment coupled to the tool drive means, this ball corresponds with a recess of the tool attachment, into which the ball is pressed due to the spring force. For pulling-off the tool attachment, the ball must again be pressed against the spring force. This results in a holding force for the tool attachment on the tool drive means, which depends on the spring force.

The connecting means can, for example, also be a bolt that can be inserted into corresponding receiving bores of the workpieces in order to orient these relative to one another and to connect them. In this case, the tool attachment comprises a blind hole, which corresponds to the external shape and the external dimensions of the bolt. As a result, the bolt can be picked with the tool attachment and be inserted (slid) into a corresponding hole of the workpiece to the axial direction thereof.

Corresponding to these described examples, the tool attachment and the tool drive means are formed for actuating a connection means for connecting at least two workpieces. The connection means can be screws or also bolts. Establishing the connection of the at least two workpieces is achieved by a movement of the connection means in the axial direction thereof. The tool attachment can be coupled and released with a tool drive means, in that the tool drive means and the tool attachment are moved relative to one another in the axial direction.

The object underlying the present invention is to propose a device and a method, in which in particular the automated establishment of a connection of at least two workpieces is simplified. The automated establishment of the connection can, in particular, be used in the production of vehicles, in particular motor vehicles. This is particularly also true for the so-called marriage, in which the chassis of the vehicle is being connected to the vehicle body.

According to the present invention, this object is achieved by a device according to claim 1, which, according to the present invention, is configured in such a way that the tool drive means comprises a fixing element acting in a form-fit manner, as well as a locking element, wherein the fixing element is locked in a fixed position in a form-fit manner depending on the position of the locking element, or is in a released position. The tool attachment is couplable and releasable, if the fixing element is released. A tool attachment placed on the tool drive means is held by the fixing element in a form-fit manner, when the fixing element is locked in the fixed position. A spring-mounted actuating element is assigned to the locking element, by means of which the locking element is held in the position in which the fixing element is locked in the fixed position in a form-fit manner. The locking element transitions to the position where the fixing element is released when the actuating element is moved or held against the spring force. Moreover, a magazine is present, having at least one tool attachment receiving space as well as releasable and blockable holding means assigned to this at least one tool attachment receiving space, by means of which holding means, if the holding means are blocked, the tool attachment is held in a form-fit and/or force-fit manner at least with respect to a movement in the axial direction relative to the holding means. The tool drive means is moveable in the axial direction with respect to the tool attachment held by the blocked holding means for coupling and decoupling of the tool attachment to or from the tool drive means. A clamping element for the actuating element is assigned to the tool attachment receiving space in such a way that the actuating element is moved against the spring force with respect to the tool drive means if the tool drive means is moved in the axial direction relative to the tool attachment held by the blocked holding means, so that the locking element transitions to the position in which the fixing element is released. Furthermore, when the tool drive means is not coupled with a tool attachment, the magazine and the tool drive means are moveable to one another in such a way that one of the at least one tool attachment receiving spaces can be positioned with respect to the tool drive means in such a way that the tool drive means can be coupled to the tool attachment with a movement in the axial direction with respect to the tool attachment held by the blocked holding means.

This configuration proves to be advantageous from various points of view.

On the one hand, the form-fit connection of a coupled tool attachment on a tool drive means results in that the tool attachment, upon actuation of connection means, is held securely and can not accidentally detach from the tool drive means. This could happen, for example, when a screw is turned at a comparatively large torque and the tool attachment clamps with respect to the screw head (or the nut) in such a way that the holding force resulting therefrom is greater than the force, which results in the holder of the tool attachment on the tool drive means described above in the context of prior art, from the force-fit connection of the tool drive means with the tool attachment. In the described case, the tool attachment would detach remain on the screw head.

For this reason, by the subject-matter of claim 1, especially in the automated operation, it is ensured that the tool attachment will not detach accidentally and must be searched for afterwards. This would also result in an interruption of production.

Despite this improved mounting of the tool attachment with respect to the captivity in the production, the present invention makes it possible to perform a change of the tool attachment in an automated manner.

Advantageously, a device is proposed, which can receive various tool attachments that can be coupled to a tool drive means. As a result, different connection means can be fastened by a change of the tool attachment. These different connection means may he, for example, screws of different sizes (i.e. in particular of different thread sizes).

The described configuration allows to perform a change of the tool attachment. The process of the change of the tool attachment is described in greater detail in conjunction with the following method claims.

The magazine provides, in a simple manner, an orderly storage of the individual tool attachments with defined placement areas, where in the tool attachments can be stored and be taken up again.

Besides the configuration of the magazine with different tool attachments, which can be changed, a configuration in which one or multiple connection means, as well as tool attachments, are stored in a magazine is also conceivable. As far as the connection means in a magazine can be actuated with one and the same tool attachment, it is sufficient to store only one tool attachment in the magazine. In this case, all connection means of a magazine can be processed with one tool drive means, because the associated tool attachments (may be even only one tool attachment) are stored in the magazine.

In the configuration according to claim 2, the magazine further comprises at least one connection means receiving space for receiving a connection means, wherein at least two workpieces can be connected to one another by means of the connection means, in that the connection means is moved, in the axial direction thereof, out of the magazine to establish a connection of the at least two workpieces by an actuation with the tool attachment, which is driven by the tool drive means, wherein the tool attachment picks the respective connection means at a tool engagement region, wherein an opening for passing the tool attachment is present in the connection means receiving space below the tool engagement region of the connection means.

In this context, reference is to be made to EP 2 416 927 B1. It is already known from this patent specification to provide a magazine having multiple receiving spaces for connection means. First, these connection means are positioned in these receiving spaces and, subsequently, held with holding means, until these connection means are picked by a tool in order to be actuated correspondingly then.

In contrast, the device according to the present invention according to claim 2 comprises a magazine, in which both connection means and one or multiple tool attachments can be stored. This proves to be advantageous because besides the stored connection means, the fitting tool attachment or the fitting tool attachments can also be stored. Through the access to a magazine formed in such a way, connections can be established in an advantageous manner with short cycle times in automated production processes.

In the configuration according to claim 3, the magazine is divided in two parts in such a way that the clamping element is moveable with respect to the holding means in the axial direction in such a way
that the clamping element and the holding element, in a first position, have a distance such that a tool drive means inserted in the magazine, the actuation element of which means is held in the position by the clamping element where the fixing element is released, and a tool attachment held in the tool attachment receiving space by the holding means are spaced from one another, and
that the clamping element and the holding means can be moved towards one another from this position into a second position, where the tool attachment is plugged onto the tool drive means or plugged into the tool drive means, wherein the tool attachment is held by the holding means even in the transition from the first position to this second position, wherein the actuating element is held by the clamping element against the spring force in the transition from the first position to this second position, so that the locking element is in the position where the fixing element is released, and
   that the tool drive means can be moved from this second position to a third position with respect to the clamping element in such a way that the tool attachment is plugged onto the tool drive means or plugged into the tool drive means and is held in this position by the fixing element, wherein, in the transition from the second to the third position, the holding means of the tool attachment receiving space are released and wherein the clamping element is released.

Advantageously, a configuration of the device is described, in which during the insertion of the tool drive means into the magazine, the actuating element is automatically moved against its spring force and held then. As a result, the fixing element is released, so that the tool attachment can be placed on to the tool drive means. Subsequently, the holding means of the tool attachment are opened. As a result, the tool attachment remains on the tool drive means. Subsequently, the clamping element is opened in such a way that the locking element transitions to the position where the fixing element is fixed and holds the tool attachment in a form-fit manner.

Claim 4 describes a configuration of the device, in which the at least one tool attachment receiving space and the at least one connection means receiving space in the magazine are arranged in one level next to one another.

As a result, the magazine remains flat as a whole.

However, it is necessary here to first move the tool drive means relative to the tool receiving space of the magazine in the axial direction, in order to plug or to insert the tool attachment on to the tool drive means.

Subsequently, the tool drive means must be positioned with the tool attachment below a connection means in a connection means receiving space, in order to subsequently be able to actuate this connection means, when said means is no longer held in the connection means receiving space.

Subsequently, the tool drive means must be moved backwards together with the tool attachment, when the connection means has been fastened. When the tool attachment is to be brought back into a tool attachment receiving space, the tool drive means must again be positioned with the tool attachment relative to a tool attachment receiving space and be moved axially.

The tool attachment is held in the tool attachment receiving space with the holding means again and the tool drive means is again moved relative to the tool attachment receiving space in the axial direction, in order to release the tool attachment from the tool drive means. This in turn occurs when the actuating element is held against the spring force in the position where the locking element is in a position in which the fixing element is released.

However, all in all, in this arrangement, space in the magazine is used well, because in the magazine only the space is required as a tool attachment receiving space that must be provided for (different) tool attachments. For the rest, the space is available for connection means receiving spaces. If, for example, only one type of connection means is stored in the magazine, it is sufficient to provide merely one tool attachment receiving space.

In an advantageous development, the magazine is configured in such a way that receiving spaces are generally present, which can be either used as tool attachment receiving space or as connection means receiving space. Here, the holding means are configured in such a way that they can hold both a tool attachment and a connection means in the receiving space.

This advantageous development makes it possible to use a magazine in a flexible manner. It is sufficient to store only one tool attachment in the magazine, when only identical connection means are stored in the magazine for the rest. If different types of connection means are stored in the magazine, a corresponding number of receiving spaces for the corresponding tool attachment can be provided in a flexible manner.

The arrangement of the tool attachment receiving spaces with respect to the connection means receiving spaces can also be provided differently.

In the embodiment according to claim 5, the magazine comprises multiple tool attachment receiving spaces, which are arranged in a first level, as well as multiple connection means receiving spaces, which are arranged in a second level. The tool attachment receiving spaces in the first level are arranged with respect to the connection means receiving spaces in such a way that a connection means in a connection means receiving space is positioned with respect to a tool attachment in a tool attachment receiving space in such a way that the tool attachment picks the connection means at the tool engagement region of the connection means if the tool attachment is moved in the axial direction of the connection means.

Thus, this claim describes a configuration in which in each case one tool attachment receiving space is located below one connection means receiving space. This allows to first couple the tool attachment from the tool attachment receiving space prior to each mounting process of a connection means through a corresponding axial movement, to then actuate the connection means, and to subsequently release the tool attachment in the tool attachment receiving space when retracting the tool attachment.

Thus, the following course of movement results:
positioning the tool drive means below the tool attachment receiving space.
Moving the tool drive means relative to the tool attachment receiving space in the axial direction for coupling the tool attachment to the tool drive means. In doing so, the tool attachment is held by the blocked holding means. The actuating element of the tool drive means is held against the spring force by means of the clamping element so that the locking element is in a position where the fixing element is released.
After the coupling of the tool attachment to the tool drive means, the holding means are released. Likewise, the clamping element is released, so that, via the actuating element, the locking element transitions to the position where the fixing element is fixed. As a result, the tool attachment is held on the tool drive means in a form-fit manner.
The tool drive means is moved with the tool attachment coupled thereto in the axial direction to the connection means and actuates it.
Once the connection means reached its end position, the tool drive means is retracted with the form-fittingly coupled tool attachment.
When the tool attachment is located in the tool attachment receiving space, the holding means are blocked. Likewise, the actuating element is held against its spring force by means of the clamping element in such a way that the locking clement is in a position where the fixing element is released.
Through a further movement of the tool drive means with respect to the tool attachment, the tool attachment is released from the tool drive means.

In this embodiment, it proves to be advantageous that a defined assignation of the connection means receiving spaces to the tool attachment receiving spaces is present. As a result, various connection means can be handled with one magazine in a simple manner.

There may a higher space requirement and also an increased demand on tool drive means when, for example, merely one type of connection means is to be used, for which actually only one tool attachment is required. The same applies if multiple similar connection means are present in the magazine, which means can be actuated with one (identical) tool attachment.

In the configuration of claim 6, the magazine comprises multiple tool attachment receiving spaces, which are arranged in a first level, as well as multiple connection means receiving spaces, which are arranged in a second level. The magazine is configured in at least two parts, in such a way that the first part with the tool attachment receiving spaces of the first level can be positioned relative to the second part with the connection means receiving spaces of the second level in such a way that a connection means in a connection means receiving space can be positioned with respect to a tool attachment on a tool attachment receiving space in such a way that the tool attachment picks the connection means at the tool engagement region of the connection means if the tool attachment is moved in the axial direction of the connection means.

This configuration corresponds to the configuration of claim 5, wherein, however, no fixed assignment of a tool attachment receiving space to a connection means receiving space is present. Due to the fact that the two parts of the can be positioned relative to one another, one tool attachment can be used for multiple identical connection means, in that the corresponding tool attachment receiving space is positioned to the respective connection means receiving space. This occurs prior to the first step of the sequence of motion described in conjunction with claim 5.

According to claim 7, the tool drive means comprises a rotatable element. The at least one connection means comprises a threaded portion. Here, the movement of the tool drive means in the axial direction for coupling to and decoupling the tool attachment from the tool drive means occurs without a rotation of the rotatable element.

Therefore, it is to be differentiated in the axial movement, whether this movement occurs for coupling and releasing the tool attachment as well as also for pulling-off the tool attachment after reaching the end position of the connection means. These movements in the axial direction are effected with a rotation of the rotatable element.

If the tool drive means is moved in the axial direction for the actuation of the connection means with the threaded portion, this occurs with a rotation of the rotatable element in order to axially move the connection means with the thread in a corresponding manner.

Here, it is in the scope of the present invention that the rotatable element is rotated with respect to the tool attachment upon coupling in such a way that the tool drive means and the tool attachment are oriented to one another in such a way that the tool attachment can be coupled with the fixing element being released. However, this rotation is limited, and advantageously takes place at a lower speed than usual in the rotation for moving the connection means with a threaded portion.

Claim 8 relates to a method for the automated connection of at least two workpieces by means of a device according to one of the preceding claims.
In a first step, the holding means are in the blocked position and block the tool attachment in a form-fit and/or force-fit manner at least with respect to a movement in the axial direction relative to the holding means. Furthermore, in this first step, the actuating element is moved or held by the clamping element against the spring-elastic force in such a way that the locking element is in the position where the fixing element is released. Moreover, in this step, the tool drive means is moved in the axial direction relative to the tool attachment held by the blocking holding means for coupling the tool attachment with the tool drive means.
In a second step, after the coupling of the tool attachment with the tool drive means, the holding means are released. Moreover, the clamping element releases the actuating element, so that the locking element transitions to the position where the fixing element is locked.
In a third step, at least one connection means is actuated by means of the tool attachment with the coupled tool drive means.
In a subsequent fourth step, the tool attachment is positioned in a tool attachment receiving space of the magazine.
In a fifth step, the holding means of this tool attachment receiving space are brought into the blocked position.
In the fourth and/or in the fifth step, the actuating element is held by the clamping element, so that the actuating element is moved or held against the spring force, so that the locking element transitions to the position where the fixing element is released.
In a sixth step, the tool drive means is moved in the axial direction relative to the tool attachment held by the blocked holding means for decoupling the tool attachment from the tool drive means.
In a seventh step, the clamping element is opened, so that the actuating element transitions to the position, due to the spring force, where the locking element has the position where the fixing element is locked.

The method according to claim 8 describes the sequence of method steps using the magazine according to one of the preceding claims. The advantages described there thus also apply to the method according to claim 8.

Claim 9 relates to an embodiment of the invention, in which multiple tool attachment receiving spaces are present in the magazine. Prior to the first step, the tool drive means and one of the tool attachment receiving spaces are being oriented to one another in such a way that in a subsequent relative movement of the tool drive means relative to this tool attachment receiving space, the tool attachment is coupled with the tool drive means.

Claim 10 relates to a configuration of the method where the tool drive means comprises a rotatable element. The at least one connection means comprises a threaded portion. The movement of the tool drive means in the axial direction relative to the tool attachment held by the blocked holding means in the coupling or decoupling to or from the tool drive means occurs without a rotation of the rotatable element.

This corresponds to the description in conjunction with claim 7, which refers to the configuration of the device.

As far as in the above-mentioned claims a relative movement is provided for of the tool drive means relative to the tool attachment held by the blocked holding means, this can be realized in that the holding means remain in their position and the tool drive means is moved. It is likewise possible that the tool drive means remains in its position and the holding means of the tool attachment are moved with respect to the tool attachment. Since the holding means are blocked, also the tool attachment is moved relative to the tool drive means. Here, the holding means can be moveable relative to the magazine. It is likewise possible that the magazine is formed in multiple parts, wherein the part having the holing means is moved as a whole. In this case, the holding means are fixedly attached to the corresponding part of the magazine and are merely switchable between the blocked and the released position.

An exemplary embodiment of the invention is represented in the drawing. The Figures show in:

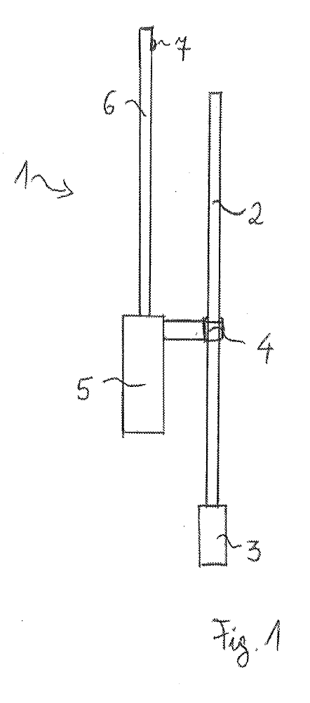

FIG. 1: an exemplary embodiment for the tool drive means,

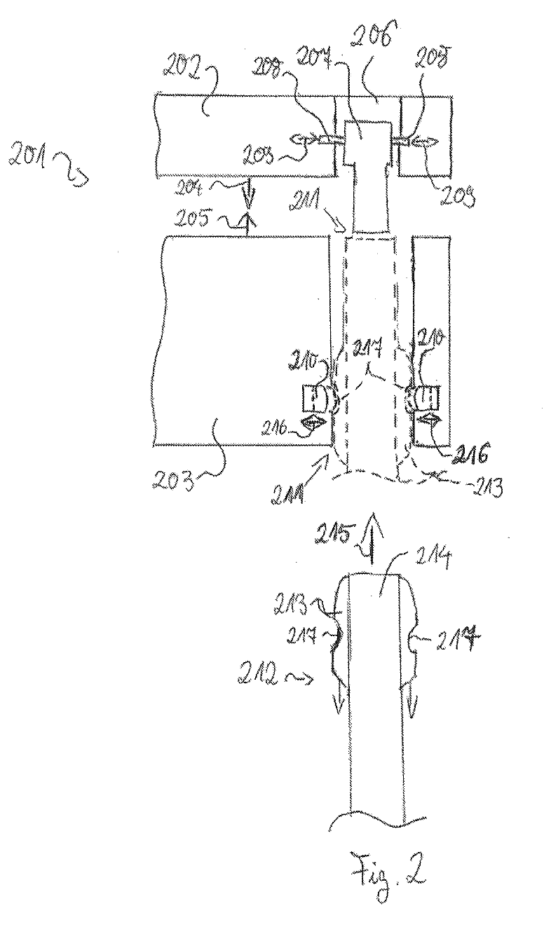

FIG. 2 to FIG. 5: a sectional view through a magazine in different positions with a tool drive means, and

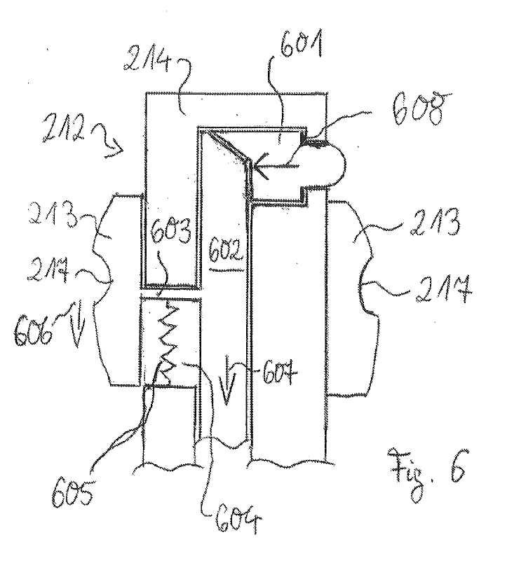

FIG. 6: a description of the basic principle of the coupling of a tool attachment to a tool drive means with a fixing element, a locking element and an actuating element.

FIG. 1 shows an exemplary embodiment for the tool drive means 1, which consists of the drive motor 5 and the spindle 6.

Furthermore, a threaded spindle 2 can be discerned, which is driven by a servo motor 3.

A guide sled 4 having a female thread is mounted on the threaded spindle 2 in a rotationally-fixed manner.

Thus, if the threaded spindle 2 is moved, the guide sled 4 is moved upward or downward.

A drive motor 5 for the spindle is mounted on the guide sled 4. The spindle 6 can be induced to rotate around its longitudinal axis by the drive motor 5.

At its upper end, the spindle 6 comprises a fitting region, onto which a tool attachment can be fitted. It can be discerned that a ball 7 partially protrudes in this fitting region.

This ball 7 can be pushed into the spindle 6, when a fixing element (not shown here) is in the released position.

A locking element is assigned to the fixing element, which can be switched back and forth between two positions.

This occurs in that an actuation element is held against a spring force in a position where the locking element is in the position where the fixing element is released.

If the actuating element is not held in this position, the actuating element transitions to a position, due to the spring force, where the locking element is in the position in which the fixing element is fixed.

The ball 7 is held thereby in a form-fit manner, so that this spindle 6 is pushed out. If this ball 7 engages in a recess of a tool attachment, an undercut is thereby formed, by means of which the tool attachment is held in a form-fit manner on the tool drive means.

The tool attachments are fitted-on over this ball 7, if the fixing element is in the released position. In the region of the ball 7, the tool attachments comprise recesses. If the fixing element is in the fixed position, the ball 7 engages in this recess of the tool attachment. Through the engagement with the recess of the tool attachment, a form-fittingly acting holding force is present for the tool attachment on the spindle 6.

If only the servomotor 3 is driven and the drive motor 5 is not driven, the tool drive means 1 (i.e. the drive motor 5 and the spindle 6) are moved upward or downward without that the spindle 6 rotates. If the drive motor 5 operates, the spindle 6 rotates.

In this embodiment, the rotational speed of the servomotor 3 is advantageously synchronized with the rotational speed of the drive motor 5 corresponding to the thread pitch of the screw, which is to be rotated as a connection means by the tool drive means 1, as well as the pitch of the threaded spindle 2. As a result, the speed of the tool drive means in the vertical direction is synchronized with the corresponding speed of the connection means.

FIG. 2 shows a section through a magazine 201. This magazine consists of two parts 202 and 203, which, corresponding to the arrows 204 and 205 from the illustrated position, in which these two parts 202 and 203 are spaced, can be moved to a position in which these parts rest one on top of the other.

In the first part 202 of the magazine 201, a tool attachment receiving space 206 is present, in which a tool attachment 207, which is formed as a wrench here, is held by means of holding means 208. The holding means 208 are moveable in accordance with the arrows 209, so that the tool attachment 207 is held in the blocked position (as represented in FIG. 2) with the holding means 208.

In the second part 203 of the magazine 201, a clamping element 210 is formed in the insertion opening 211 for a tool drive means 212.

This clamping element 210 consists of elements that are moveable corresponding to the arrows 216 in such a way that these release the insertion opening 211 or are engaged with a recess 217 on the actuating element 213 of the tool drive means 212.

Merely the shaft 214 is drawn of the tool drive means 212, into which the tool attachment 207 is inserted.

If the tool drive means 212 is inserted into the insertion opening 211 of the second part 203 of the magazine 201, here, the actuating element 213 is held in the position, corresponding to the dashed illustration in FIG. 2, in that the elements of the clamping element 210 are inserted into to recess 217 of the actuating element 213. The actuating element 213 is thereby held fixed against the spring force when the tool drive means 212 is inserted into the insertion opening 211 of the second part 203 of the magazine 201.

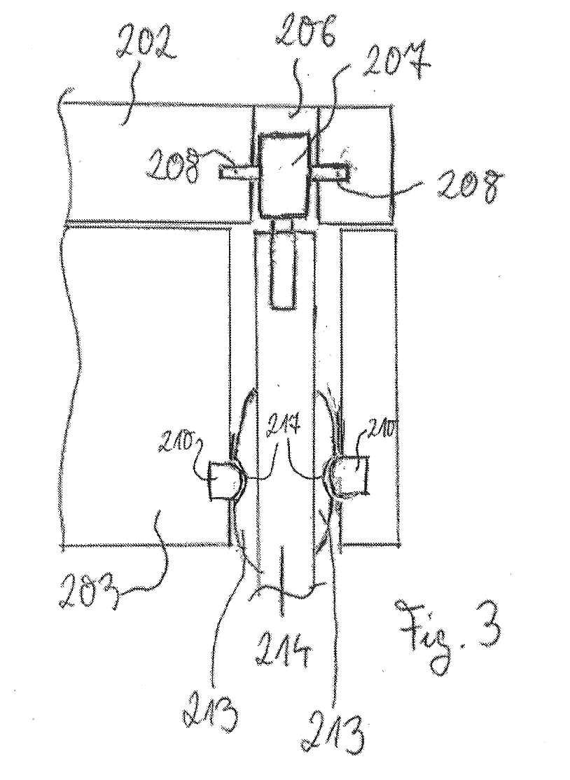

FIG. 3 shows the parts of FIG. 2, wherein the first part 202 of the magazine 201 as well as the second part 203 of the magazine 201 have been moved toward one another corresponding to the direction of the arrows 204 and 205 of FIG. 2 so that these two parts 202 and 203 of the magazine 201 rest one on top of the other.

The tool attachment 207 is held with respect to the first part 202 of the magazine 201 by the blocked holding means 208. The tool drive means 212 is fixedly positioned with respect to the second part 203 of the magazine 201. As a result of the movement of the two parts 202 and 203 to one another, the tool drive means 212 is moved in the axial direction relative to the tool attachment 207.

The holding means 208 of the tool attachment 207 continue to hold the tool attachment 207.

The actuating element 213 of the tool drive means 212 is held against the spring force by the clamping element 210, which is inserted into the recess 217 of the actuating element 213.

As a result, the locking element is in the position where the fixing element is released. As a result, the tool attachment 207 can be inserted into the shaft 214 of the tool drive means 212.

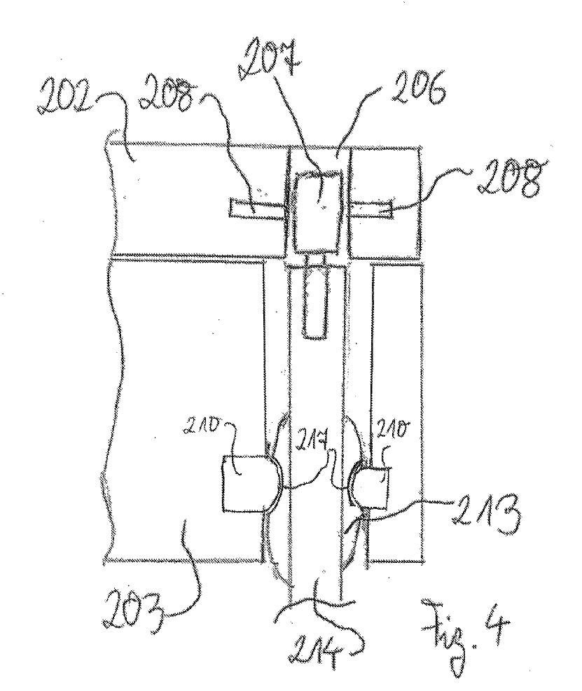

FIG. 4 shows how the holding means 208 of the tool attachment 207 are released in the next step before pulling-out the tool drive means 212 from the magazine 201. As a result, the tool attachment 207 remains in the shaft 214 when the tool drive means 212 is subsequently pulled out from the magazine 201. In this position of FIG. 4, the clamping element 210 still engages into the recess 217 of the actuating element 213 and holds it against the spring force.

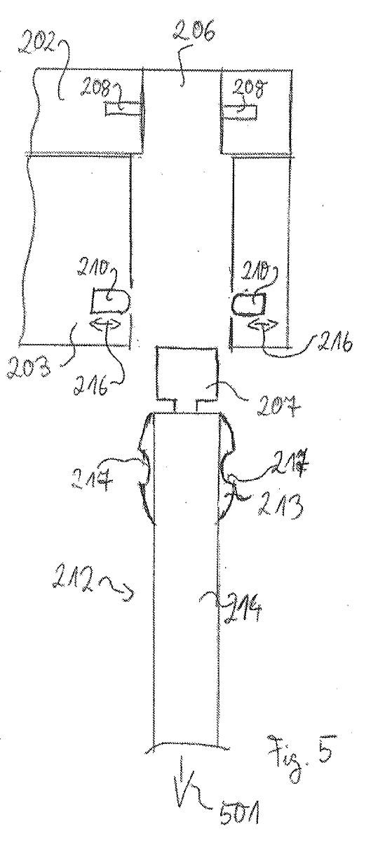

FIG. 5 shows how the tool drive means 212 is pulled out of the magazine 201 corresponding to the direction of the arrow 501.

Here, the tool attachment 207 is located on the tool drive means 212.

The holding means 208 of the tool attachment 207 are released. The clamping element 210 is likewise released. This occurs in that the elements of the clamping element 210 are pulled out of the recess 217 of the actuating element 213 corresponding to the arrows 216. As a result, the actuating element 213 is released and moves to the position, due to the acting spring force, where the locking element is in the position in which the fixing element is fixed in a form-fitting manner.

The tool attachment 207 is thereby held on the tool drive means 212 in a form-fitting manner and is available for further mounting works.

In the case that the tool attachment is to be removed from the tool drive means after performing the mounting work, and be stored in the tool receiving space 206 of the magazine 201, this occurs in the order of the FIGS. 5, 4, 3, and 2.

In the first step, corresponding to the illustration of FIG. 5, the tool drive means 212 is inserted into the magazine in the tool receiving space 206 with opened holding means 208. This occurs against the direction of the arrow 501.

Here, the elements of the clamping element 210 are inserted into the recess 217 of the actuating element 213. If the tool drive means 12 is further inserted into the magazine 201, the actuating element 213 is thereby moved to the position, and held there, where the locking element is in the position in which the fixing element is released.

The tool attachment 207 is still located in the shaft 214. The holding means 208 of the tool attachment receiving space 206 are still open. This corresponds to the illustration of FIG. 4.

Subsequently, corresponding to the representation of FIG. 3, the holding means 208 are brought into the position where the tool attachment 207 is blocked.

In the next step, corresponding to the representation of FIG. 2 (dashed illustration of the tool drive means 212), the two parts 202 and 203 of the magazine 201 are moved away from one another against the direction of the arrows 204 and 205. In particular, the tool attachment 206, which is held by the blocked holding means 208 with respect to the part 202 of the magazine 201, is lifted off from the tool drive means 212 as well. Here, the fixing element is still released.

As a result, when the two parts 202 and 203 of the magazine 201 are moved away from each other, the tool attachment 207 is pulled out from the shaft 214 of the tool drive means 212.

Subsequently, the tool drive means 212 is pulled out from the magazine 201 against the direction of the arrow 215, with a released clamping element 210, and can be re-equipped with another tool attachment.

The exemplary embodiment in the Figures merely shows the coupling to and decoupling of a tool attachment 207 from the tool drive means 212. If the magazine is constructed in such a way that the tool attachment receiving space(s) 206 are arranged in a first level and the connection means receiving spaces are arranged directly above it, it can be seen that the insertion opening 211 and also the tool attachment receiving space must be dimensioned in terms of the clear width in such a way that at least the shaft 214 with the actuating element 213 of the tool drive means 212 can be guided through the insertion opening 211 as well as possibly also the tool attachment receiving space 206 in order to move the connection means out from the connection means receiving space arranged there-above to its mounting position.

FIG. 6 shows a description of the basic principle of the coupling of a tool attachment (not shown here) to a tool drive means 212 with a fixing element 601, a locking element 602 and a actuating element 213.

A section through the tool drive means 212 is represented.

The actuating element 213 can be discerned, which is connected to a locking element 602 via a connection element 603. Said connection element 603 is supported in an axial longitudinal slot 604 extending inside the shaft 214 of the tool drive means 212. Thereby, a unit formed by the actuating element 213 via the connection element 603 with the locking element 602 is movable in axial direction relative to the shaft 214 of the tool drive means 212. The locking element 602 extends in a bore inside the shaft 214 of the tool drive means 212.

It can be seen that the unit composed of the actuating element 213, the connection element 603 and the locking element 602 is spring-elastically mounted (605) and held in the position, due to the spring force, which is shown in FIG. 6.

The actuating element 213 is displaceable in the axial direction in relation to the shaft 214 of the tool drive means against the spring force (605) in the direction of the arrow 606. Due to the fact that the locking element 602 is coupled with the actuating element 213 via the connection element 603, the locking element 602 is moved along in the direction of the arrow 607 when the actuating element 213 is moved in the direction of the arrow 606.

As a result, the space that lies behind the fixing element 601 in the bore hole in the shaft 214 in the direction of the arrow 608 is made accessible. Upon an application of force in the direction of the arrow 608, the fixing element 601 moves into the shaft 214 flush with the outer surface of the shaft 214.

In the situation illustrated in FIG. 6, the locking element 602 fills the space, so that the fixing element 601 is prevented, in a form-fitting manner, from moving into the shaft 214, when a force acts on the fixing element 601 from outside.

The contact surfaces of the fixing element 601 as well as of the locking element 602 to one another are designed in such a way that this surface, in the bottom part of the fixing element 601, extends perpendicular, i.e. in the axial direction of the shaft 214. In the upper part, these contact surfaces extend in a manner as to have an inclination. When the locking element 602 has been moved downward against the spring force 605 and the fixing element 601 is moved in the shaft 214, the inclined course of the contact surfaces in the upper region achieves that the fixing element 601 is pressed outward again, and thus avoids the locking element, when it transitions to the position, along with the spring force 605, which is shown in FIG. 6. It is achieved through the vertical portion of the contact surfaces that the fixing element 601 is held and fixed in a form-fit manner when the locking element is in the position shown in FIG. 6. An application of force in the direction of the arrow 608 to the fixing element 601, because of the vertical portion of the contact surface, does not result in the locking element 602 being pressed downward.

In the actuating element 213, the recess 217, into which the clamping element 210 engages, can be seen again.

It proves to be advantageous when the locking element 602 and the fixing element 601 fill the respective bore hole in the shaft 214 completely, as possible. This means that the locking element 602 and the fixing element 601 but, with their surfaces, against the respective wall of the bore holes. As a result, movability of the locking element 601 as well as of the fixing element 601 is ensured. Moreover, this achieves that the shaft, as a whole, remains dimensionally stable to the greatest possible extent and has a good mechanical strength, in particular with regards to torsional stress and bending stress.

1. A device for the automated coupling and decoupling of a tool attachment (207) to or from a tool drive means (212), wherein the tool attachment (207) and the tool drive means (212) are configured to actuate a connection means for the connection of at least two workpieces by means of a movement of the connection means in the axial direction thereof, wherein the tool attachment (207) can be coupled with and also decoupled from the tool drive means (212) in that the tool drive means (212) and the tool attachment (207) are moved relative to one another in the axial direction, characterized in that
the tool drive means (212) comprises a fixing element (601) acting in a form-fit manner, as well as a locking element (602), wherein the fixing element (601), depending on the position of the locking element (602), is locked in a fixed position in a form-fit manner or is in a released position, wherein the tool attachment (207) is couplable and releasable, when the fixing element (601) is released, and wherein a tool attachment (207) placed on the tool drive means (212) is held by the fixing element (601) in a form-fit manner when the fixing element (601) is locked in the fixed position, wherein the locking element (602) forms (603) a spring-mounted (605) unit with an actuating element (213), wherein the locking element (602) is held by the spring force (605) in the position where the fixing element (601) is locked in the fixed position in a form-fit manner, wherein the locking element (602) transitions to the position where the fixing element (601) is released when the actuating element (213) is moved or held against the spring force (605),
a magazine (201) is present, having at least one tool attachment receiving space (206) as well as releasable and blockable holding means (208) assigned to the at least one tool attachment receiving space (206), by means of which holding means, if the holding means (208) are blocked, the tool attachment (207) is held in a form-fit and/or force-fit manner at least with respect to a movement in the axial direction relative to the holding means (208), in that the tool drive means (212) is moveable in the axial direction with respect to the tool attachment (207) held by the blocked holding means (208) for coupling or decoupling the tool attachment (207) with or from the tool drive means (212),
the tool attachment receiving space (206) is assigned a clamping element (210) for the actuating element (213) in such a way that the actuating element (213) is moved against the spring force (605) with respect to the tool drive means (212) if the tool drive means (212) is moved in the axial direction relative to the tool attachment (207) held by the blocked holding means (208), so that the locking element (602) transitions to the position where the fixing element (601) is released, and
when the tool drive means (212) is not coupled with a tool attachment (207), the magazine (201) and the tool drive means (212) are moveable to one another in such a way that one of the at least one tool attachment receiving spaces (206) can be positioned with respect to the tool drive means (212) such that the tool drive means (212), with a movement in the axial direction with respect to the tool attachment (207) held by the blocked holding means (208), can be coupled with the tool attachment (207).

2. The device according to claim 1,
characterized in that the magazine (201) further comprises at least one connection means receiving space for receiving a connection means, wherein at least two workpieces can be connected with one another by means of the connection means, in that the connection means is moved, in the axial direction thereof, out of the magazine (201) for establishing a connection of the at least two workpieces by an actuation with the tool attachment (207), which is driven by the tool drive means (212), wherein the tool attachment (207) picks the respective connection means at a tool engagement region, wherein an opening for passing through at least the tool attachment (207) and, if appropriate, also the tool drive means (212) is present in the connection means receiving space below the tool engagement region of the connection means.

3. The device according to claim 1 or 2,
characterized in that the magazine (201) is divided in two parts in such a way (202, 203) that the clamping element (210) can be moved with respect to the holding means (208) in the axial direction in such a way
that the clamping element (210) and the holding element (208), in a first position, have a distance such that a tool drive means (212) inserted in the magazine (201), the actuation element (213) of which means is held in the position by the clamping element (210) where the fixing element (601) is released, and a tool attachment (207) held in the tool attachment receiving space (206) by the holding means (208) are spaced from one another, and
that the clamping element (210) and the holding means (208) can be moved towards one another from said first position into a second position, where the tool attachment (207) is plugged onto the tool drive means (212) or plugged into the tool drive means (212), wherein the tool attachment (207) is held by the holding means (208) even in the transition from the first position to this second position, wherein the actuating element (213) is held by the clamping element (210) against the spring force (605) in the transition from this first position to the second position, so that the locking element (602) is in the position where the fixing element (601) is released, and
that the tool drive means (212) can be moved from this second position to a third position with respect to the clamping element (210) in such a way that the tool attachment (207) is plugged onto the tool drive means (212) or plugged into the tool drive means, respectively and is held in this position by the fixing element (601), wherein, in the transition from the second to the third position, the holding means (208) of the tool attachment receiving space (206) are released and wherein the clamping element (210) is released.

4. The device according to one of claims 2 or 3,
characterized in that
the at least one tool attachment receiving space (206) and the at least one connection means receiving space are arranged in one level next to one another in the magazine (201).

5. The device according to one of claims 2 or 3,
characterized in that the magazine (201) comprises multiple tool attachment receiving spaces (206), which are arranged in a first level, as well as multiple connection means receiving spaces, which are arranged in a second level, wherein the tool attachment receiving spaces (206) are positioned in the first level with respect to the connection means receiving spaces in the second level in such a way that a connection means in a connection means receiving space is positioned with respect to a tool attachment (207) in a tool attachment receiving space (206) in such a way that the tool attachment (207), in a movement of the tool attachment (207) in the axial direction of the connection means, picks the connection means at the tool engagement region of the connection means.

6. The device according to one of claims 2 or 3,
characterized in that the magazine (201) comprises one or multiple tool attachment receiving spaces (206), which are arranged in a first level, as well as multiple connection means receiving spaces, which are arranged in a second level, wherein the magazine (201) is formed at least in two parts in such a way that the first part with the tool attachment receiving spaces (206) of the first level can be positioned with respect to the second part with the connection means receiving spaces of the second level in such a way that a connection means in a connection means receiving space is positioned with respect to a tool attachment (207) in a tool attachment receiving space (206) in such a way that the tool attachment (207), in a movement of the tool attachment (207) in the axial direction of the connection means, picks the connection means at the tool engagement region of the connection means.

7. The device according to one of claims 1 to 6,
characterized in that the tool drive means (212) comprises a rotatable element (214) and in that the at least one connection means comprises a threaded portion, wherein the movement of the tool drive means (212) in the axial direction for coupling or decoupling of the tool attachment (207) from the tool drive means (212) is effected without a rotation of the rotatable element (214).

8. A method for the automated connection of at least two workpieces by means of a device according to one of the preceding claims,
characterized in that
in a first step, the holding means (208), in the blocked position, block the tool attachment (207) in a form-fit and/or force-fit manner at least with respect to a movement in the axial direction relative to the holding means (208), that in this first step, furthermore the actuating element (213) is moved or held by the clamping element (210) against the spring-elastic force (605) in such a way that the locking element (602) is in the position where the fixing element (601) is released, that in this first step the tool drive means (212) is moved in the axial direction relative to the tool attachment (207) held by the blocked holding means (208) for coupling the tool attachment (207) with the tool drive means (212),
in a second step, after the coupling of the tool attachment (207) with the tool drive means (212), the holding means (208) are released as well as the clamping element (210) releases the actuating element (213), so that the locking element (602) transitions to the position where the fixing element (601) is locked,
in a third step, at least one connection means is actuated by means of the tool attachment (207) with the coupled tool drive means (212),
in a subsequent fourth step, the tool attachment (207), in turn is positioned in a tool attachment receiving space (206) of the magazine,
in a fifth step, the holding means (208) of this tool attachment receiving space (206) are brought into the blocked position,
wherein in the fourth and/or in the fifth step, the actuating element (213) is held by the clamping element (210), so that the actuating element (213) is moved or held against the spring force (605), so that the locking element (602) transitions to the position where the fixing element (601) is released,
in a sixth step, the tool drive means (212) is moved in the axial direction relative to the tool attachment (207) held by the blocked holding means (208) for decoupling the tool attachment (207) from the tool drive means (212),
in a seventh step, the clamping element (210) is opened, so that due to the spring force (605), the actuating element (213) transitions to the position where the locking element (602) has the position where the fixing element (601) is locked.

9. The method according to claim 8,
characterized in that multiple tool attachment receiving spaces (206) are present in the magazine (201), wherein, prior to the first step, the tool drive means (212) and one of the tool attachment receiving spaces (206) are oriented to one another in such a way that in the subsequent relative movement of the tool drive means (212) relative to the tool attachment (207) of this tool attachment receiving space (206) held by the blocked holding means (208), the tool attachment (207) is coupled with the tool drive means (212).

10. The method according to one of claims 8 or 9,
characterized in that the tool drive means (212) comprises a rotatable element (214) and that the at least one connection means comprises a threaded portion, wherein the movement of the tool drive means (212) in the axial direction relative to the tool attachment (207) held by the blocked holding means (208) occurs in the coupling or decoupling of the tool attachment (207) to or from the tool drive means (212) without a rotation of the rotatable element (214).
